(19) United States
(12) Patent Application Publication
(10) Pub. No.: US 2005/0070287 A1
(43) Pub. Date: Mar. 31, 2005

(54) Method for soft/softer handover for wireless communication systems

(75) Inventors: Christopher Cave, Candiac (CA); Vincent Roy, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/748,775

(22) Filed: Dec. 30, 2003

Related U.S. Application Data
(60) Provisional application No. 60/506,252, filed on Sep. 26, 2003.

(51) Int. Cl. H04Q 7/20

(52) U.S. Cl. 455/436; 455/446

(57) ABSTRACT

Soft/softer handover is to be performed in a wireless hybrid code division multiple access communication system. For a wireless transmit/receive unit (WTRU), currently used uplink and downlink timeslots of the WTRU in a current cell/sector are determined. Uplink and downlink timeslots are assigned to the WTRU for a handover cell/sector. The assigned handover cell/sector uplink and downlink timeslots are different timeslots than the currently used current cell/sector uplink and downlink timeslots. After initiating soft handover, same uplink and downlink data with the current cell/sector is communicated using the currently used uplink and downlink timeslots and with the handover cell/sector using the assigned handover cell/sector uplink and downlink timeslots.

### CROSS REFERENCE TO RELATED APPLICATION(S)

This application claims priority from U.S. provisional application No. 60/506,252 filed on Sep. 26, 2003, which is incorporated by reference as if fully set forth.

### FIELD OF INVENTION

This invention generally relates to wireless communication systems. In particular, the invention relates to handover in such systems.

### BACKGROUND

As wireless users move in wireless communication systems, their communications are handed-over between base stations. To illustrate as shown in FIG. 1, as a wireless user 24 moves out of the range of a base station 22₁ in a cell 1 20₁, the communication links with that user are handed-over to another base station 22₂ in cell 2 20₂. Current wireless systems use two types of handover between base stations 22₁, 22₂ (22), hard handover and soft handover.

In hard handover, the communication link with base station 1 22₁ is broken prior to establishment of the communication link with base station 2 22₂, (referred to as “break then make”). In soft handover, the communication link with base station 2 22₂ is established prior to breaking the link with base station 1 22₁, (referred to as “make then break”). In soft handover, a period of time exists where both base stations 22 have communication links with the wireless user 24.

Another type of handover, as illustrated in FIG. 2, is softer handover. Softer handover occurs between sectors 26₁, 26₂, 26₃ (26) of a single cell 20. As the user 24 moves from sector 1 26₁ to sector 2 26₂, a communication link with sector 2 26₂ is made prior to breaking the link with sector 1 26₁. As a result, for a period of time, the wireless user 24 has communication links with two sectors.

For a period of time in soft and softer handover, the wireless user 24 is communicating with two sectors 26 or cells 20. To take advantage of these redundant links, data sent over the redundant links is either combined or data from the better link is selected. To illustrate in the uplink for softer handover and in the downlink for both soft and softer handover, data over the two links is combined, typically at the symbol level. Since the two links have differing fading characteristics, a diversity gain is achieved, producing a signal with a superior signal to interference ratio (SIR).

To illustrate in the uplink for soft handover, two different base stations 22 receive data from a wireless user 24. Both base stations send this data to the radio network controller (RNC) which selects the data with the best received signal quality. Since each base station 22 experiences distinct path losses, shadowing and fading conditions, a selection diversity gain is achieved.

For the current proposed universal mobile terrestrial system (UMTS) wideband code division multiple access (W-CDMA) time division duplex (TDD) mode, hard handover is utilized. Soft and softer handover are not used.

Soft and softer handover have implementation problems in TDD/CDMA communication systems. Current TDD/CDMA systems do not support the simultaneous decoding of signals from multiple cells by the wireless user 24 or multiple base stations simultaneously decoding signals from one wireless user 24. These limitations occur since time slot synchronization between cells is not guaranteed and each cell has its own cell specific scrambling code for the uplink and downlink. Multi-user detection (MUD) receivers, utilized in such systems, are configured to only detect signals send using one cell specific scrambling code at a time.

Additionally, the uplink and downlink time slot assignments may not be the same between cells, making the assignment of timeslots for soft/softer handover difficult. The number of channelization codes is limited, such as to sixteen codes, limiting the flexibility for code allocations for soft/softer handover.

Since handover occurs at the edges of cells 20 or sectors 26, the signal quality in the handover area tends to be poorer than other areas of the cell. The use of soft/softer handover allows for a diversity The term diversity includes all diversity schemes including selection diversity) gain to compensate for the poorer signal conditions. Hard handover does not allow for such gains. Accordingly, it is desirable to use soft/softer handover in TDD/CDMA communication systems.

### SUMMARY

Soft/softer handover is to be performed in a wireless hybrid code division/time division multiple access communication system. For a wireless transmit/receive unit (WTRU), currently used uplink and downlink timeslots of the WTRU in a current cell/sector are determined. Uplink and downlink timeslots are assigned to the WTRU for a handover cell/sector. The assigned handover cell/sector uplink and downlink timeslots are different timeslots than the currently used current cell/sector uplink and downlink timeslots. After initiating soft handover, same uplink and downlink data with the current cell/sector is communicated using the currently used uplink and downlink timeslots and with the handover cell/sector using the assigned handover cell/sector uplink and downlink timeslots.

### BRIEF DESCRIPTION OF THE DRAWING(S)

FIG. 1 is an illustration of handover.

FIG. 2 is an illustration of softer handover.

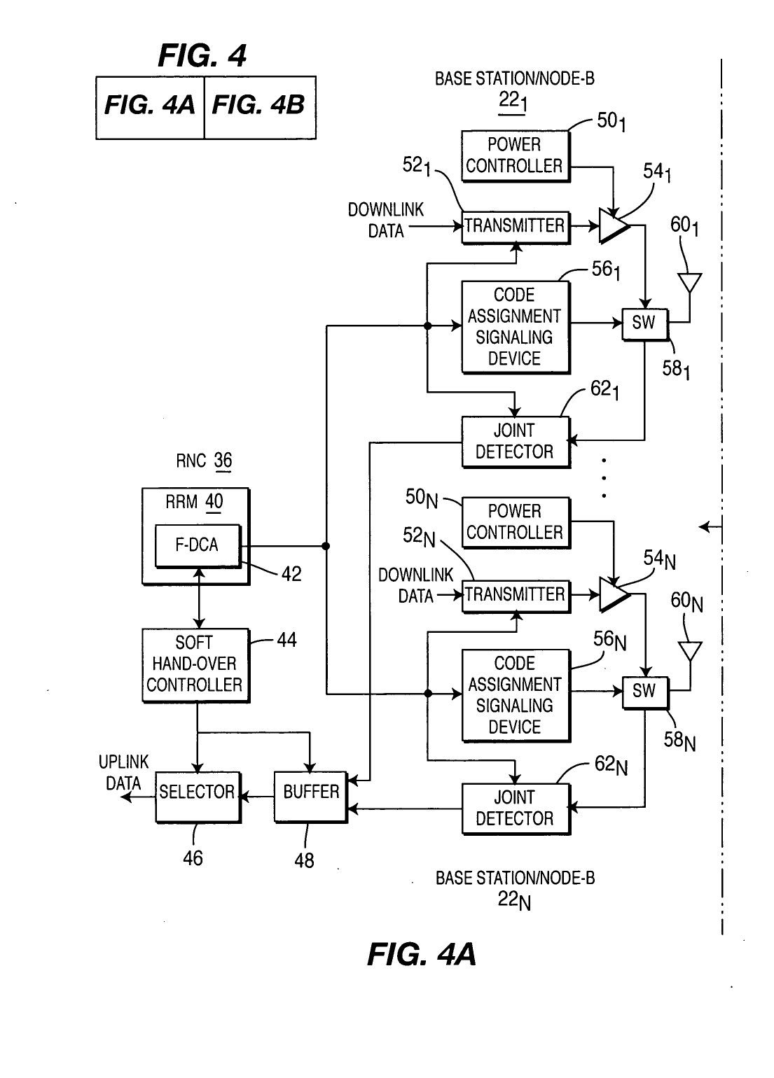

FIG. 3 is a flow diagram of soft/softer handover in a hybrid time division multiple access/code division multiple access system.

FIG. 4, including FIGS. 4A and 4B, is an embodiment of a soft handover system.

FIG. 5, including FIGS. 5A and 5B, is an embodiment of a softer handover system.

FIG. 6 is a flow diagram of using both soft and hard handover.

### DETAILED DESCRIPTION OF THE PREFERRED EMBODIMENT(S)

Although the preferred embodiments are described in conjunction with a third generation partnership program (3GPP) UMTS W-CDMA TDD mode, the embodiments are extendable to any hybrid code division multiple access (CDMA)/time division multiple access (TDMA) communication system.

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a base station, Node-B, site controller, access point or other interfacing device in a wireless environment.

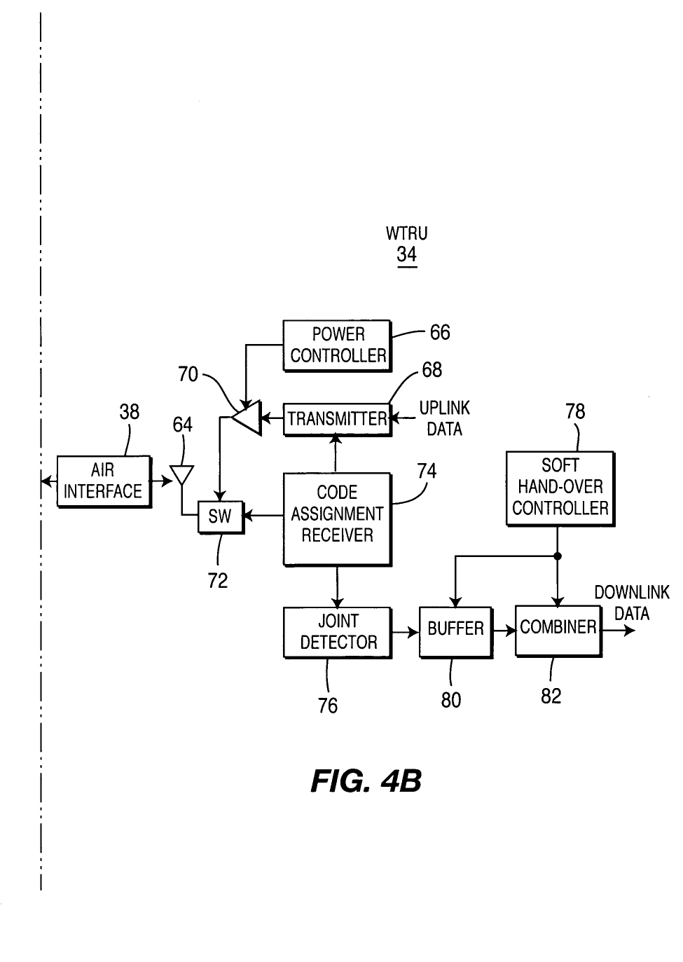

FIG. 3 is a flow diagram of soft/softer handover for a hybrid TDMA/CDMA system. Either soft handover or softer handover is initiated for a WTRU 34 (step 28). The WTRU 34 is initially communicating with a particular base station/Node-B 22 and has assigned uplink and downlink codes and timeslots. A fast dynamic channel allocation (F-DCA) is initiated to assign the WTRU 34 uplink and downlink codes/timeslots to support soft/softer handover (step 30). The assigned timeslots are timeslots that the WTRU 34 is not using for its current communications and are timeslots that have available codes (not already at capacity). Preferably, the neighboring base stations 22 are time synchronized so that their time slots are substantially time synchronized.

The WTRU 34 is assigned different timeslots so that it can communicate to the differing cells/sectors at a different time. As a result, the WTRU 34 does not need to decode signals from two different base stations 22 or base station sectors at the same time. Similarly, each base station 22/sector does not need to simultaneously decode signals of a WTRU 34 from another base station/sector. In the proposed 3GPP W-CDMA TDD mode, such a technique allows for the WTRU 34 and base station 22/sectors to only process one base station's scrambling code at a time. By only processing only one base station's scrambling code allows conventional joint detectors, such as MUDs, to be utilized.

In the advent where the two cells involved in the soft handover would have different downlink/uplink timeslot allocations, the F-DCA should preferably not consider the timeslots that are used in different directions by the two cells when allocating timeslots resources to the WRTU in soft handover. For example, if slot 1 is used on the uplink in cell 1 20₁ and on the downlink in cell 2 20₂, that slot should preferably not be considered for a user in soft handover. Conversely, if slot 1 is used on the downlink in cell 1 20₁ and on the uplink in cell 2 20₂, that slot should preferably not be considered for a user in soft handover. Optionally, the F-DCA should give a lower priority to timeslots that are used in different directions by the two cells when allocating timeslot resources to the WRTU in soft/softer handover.

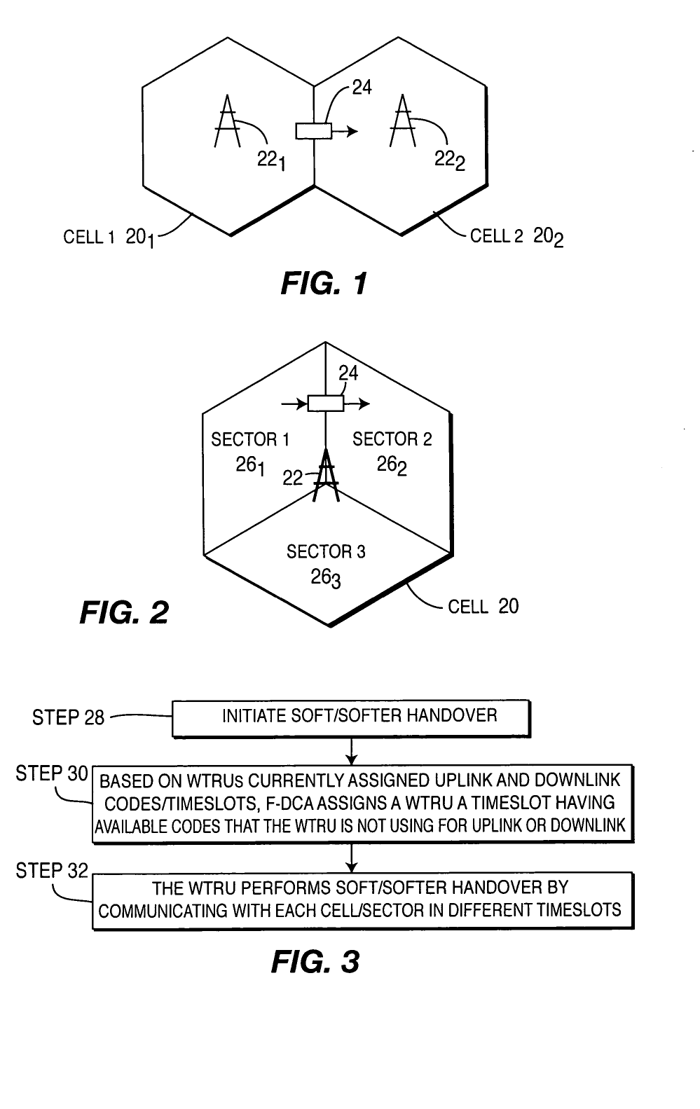

Using the assigned codes/timeslots, the WTRU performs soft/softer handover (step 32). To using FIG. 1, the wireless user 24 is being handed-over from cell 1 20₁ to cell 2 20₂. In cell 1 20₁, the user 24 utilizes timeslot 1 for the uplink and timeslot 2 for the downlink. F-DCA assigns the user 24 timeslot 3 for the uplink and timeslot 4 for the downlink for cell 2 20₂. During soft handover, the user communicates in the uplink to cell 1 20₁ using timeslot 1 and cell 2 20₂ using timeslot 3 and in the downlink to cell 1 20₁ using timeslot 2 and cell 2 20₂ using timeslot 4.

The use of soft/softer handover in hybrid TDD/CDMA systems allows for diversity gain in both the uplink and downlink. The increased gains allow for improved cell range, more uniform cell coverage and increased cell capacity. Soft/softer handover allows for more robust handovers.

In TDD systems, the approach of FIG. 1 favors time slot packing. Time slot packing is when the assigned channelization codes used in a cell are packed into a few timeslots and not spread out so that a few codes are assigned to many timeslots. Slot packing is desirable, since it adds flexibility to future radio resource management (RRM) procedures. Without soft/softer handover, a WTRU 34 at the edge of a cell typically spreads its codes across time slots to improve coverage. With soft/softer handover, the diversity gains can relieve a WTRU 34 at the cell edge and allow for slot packing.

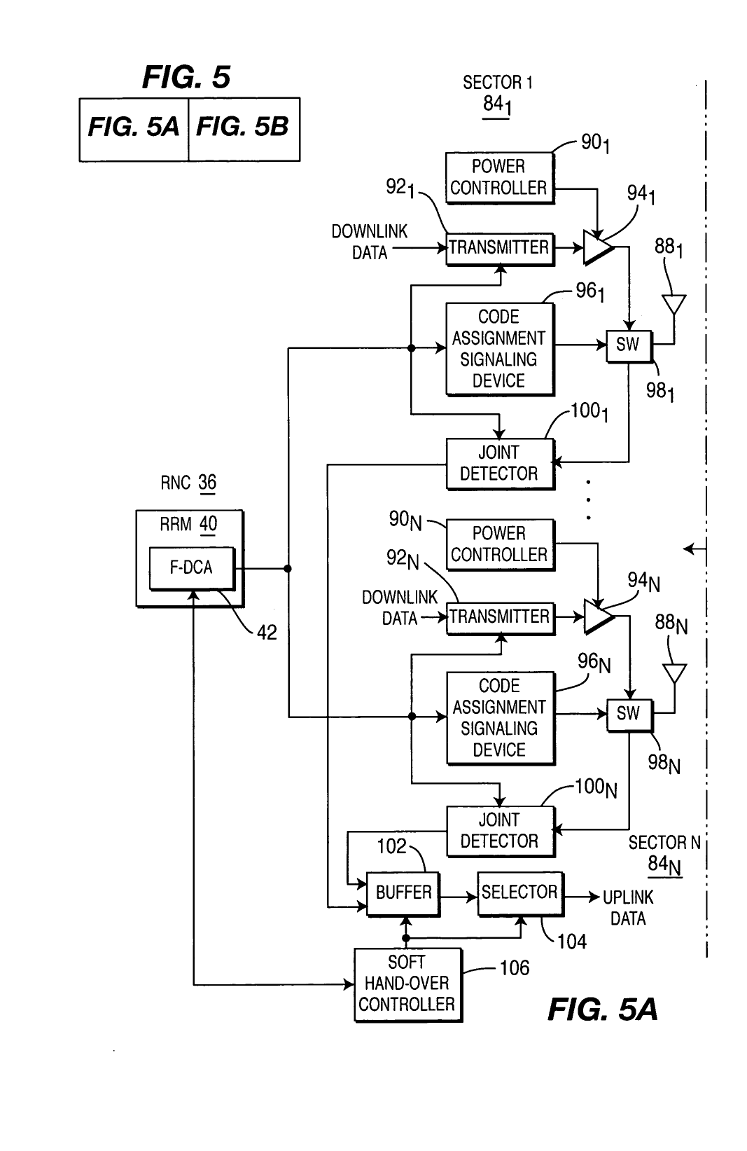

FIG. 4 is a simplified block diagram of a soft handover system. A radio network controller (RNC) 36 has a radio resource management device 40 with a F-DCA device 42. F-DCA 42 selects the codes/timeslots for both uplink and downlink soft handover. The code/timeslot assignments are sent to the base stations/Node-Bs 22₁ to 22_{N} (22) participating in soft handover. Each base station/Node-B 22 has a code assignment signaling device 56₁ to 56_{N} for signaling the code/timeslot assignment to the WTRU 34. Downlink data for each base station/Node-B 22 is transmitted using a transmitter 52₁ to 52_{N}. An amplifier 54₁ to 54_{N} controls the transmission power level in response to a power controller 501 to 50N. The transmitted signal passes though a duplexer or switch (SW) 58₁ to 58_{N} (58) and is radiated by an antenna or antenna array 60₁ to 60_{N} (60).

After passing through the air interface 38, an antenna or antenna array 64 at the WTRU 34 receives the transmitted signals from each base station/Node-B 22. The received signals pass through a duplexer or switch 72 to a joint detection device 76, such as a MUD. Each base station/Node-B's downlink data is detected by the joint detector 76. The soft symbols of the detected downlink data from each of the N timeslots is stored in a buffer 80. Each version of the soft symbols of the detected data received in the N timeslots are then preferably combined by a combiner 82 to produce the downlink data. Alternately, instead of combining, the base station/Node-B data having the best received quality is selected. The buffering and combining is controlled by a soft handover controller 78.

A code assignment receiver 74 receives the code assignments sent by the base stations/Node-Bs 22. For the uplink, uplink data is processed by a transmitter 68. An amplifier 70 controls the transmission power level in response to a power controller 66. Each radio link the WRTU maintains with the Node-Bs may have distinct power control settings since they are transmitted in different timeslots. The amplified signal passes through a duplexer or switch 72 and is radiated by the antenna/antenna array 64 through the air interface 38.

Each base station's/Node-B's antenna or antenna array 60 receives the uplink transmissions. These received signals pass through a duplexer or switch 58 to a joint detector 62₁ to 62_{N} (62), which recovers the uplink data. The data produced by each joint detector 62 is stored in a buffer 48 at the RNC 35. A selector 46 selects the recovered uplink data from the base station/Node-B 22 having the better received signal quality. The selector 46 and buffer 48 are controlled by a soft handover controller 44.

Since the WTRU 34 is receiving and sending communications from multiple base stations/Node-Bs 22 in a radio frame, the uplink and downlink power control are preferrably treated differently for each of the multiple Node-Bs 22. For implementation with a UMTS W-CDMA TDD mode system, downlink power control is implemented using a closed loop algorithm, by transmitting power commands. In soft handover, the WTRU 34 transmits different power commands to each base station/Node-B 22 to control the power of each link separately.

Uplink power control for a W-CDMA TDD system uses an outer loop/weighted open loop power control algorithm. In this algorithm, the WTRU 34 measures the received signal code power (RSCP) of each base station's primary common control physical channel (P-CCPCH). The RSCP measurement is used to determine a pathloss from each base station 22 to the WTRU 34. When the base stations 22 are transmitting their P-CCPCHs in different time slots, the uplink transmission power control is set using the measured RSCPs from each P-CCPCH.

If the P-CCPCHs are transmitted in the same timeslot, the WTRU 34 can alternate the RSCP measurements between radio frames. To illustrate, in frame 1, the WTRU 34 monitors a first base station's P-CCPCH and in frame 2, a second base station's P-CCPCH and in frame 3, the first base station's P-CCPCH again.

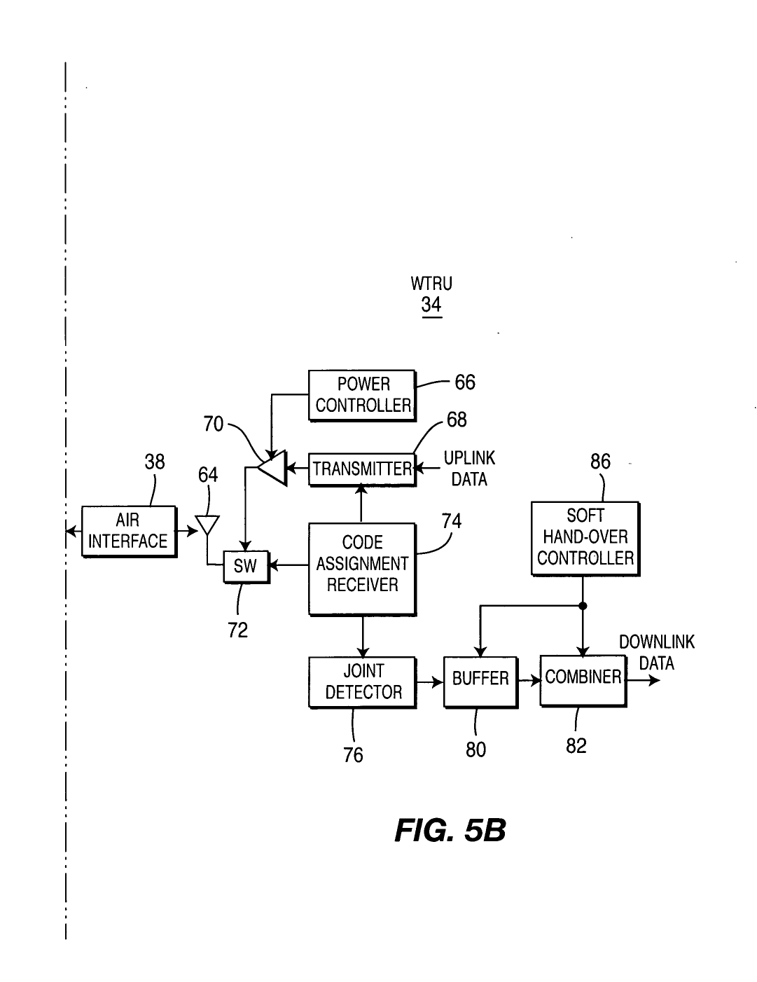

FIG. 5 is a simplified block diagram of a softer handover system. A radio network controller (RNC) 36 has a radio resource management device 40 with a F-DCA device 42. F-DCA 42 selects the codes/timeslots for both uplink and downlink softer handover. The code/timeslot assignments are sent to the base station/Node-B 22. Each sector 84₁ to 84_{N} (84) of the base station/Node-B 22 has a code assignment signaling device 96₁ to 96_{N} for signaling the code/timeslot assignment to the WTRU 34. Downlink data for each base station/Node-B 22 is transmitted using a transmitter 92₁ to 92_{N}. An amplifier 94₁ to 94_{N} controls the transmission power level in response to a power controller 90₁ to 90_{N}. The transmitted signal passes though a duplexer or switch (SW) 98₁ to 98_{N} (98) and is radiated by an antenna or antenna array 88₁ to 88_{N} (88).

After passing through the air interface 38, an antenna or antenna array 64 at the WTRU 34 receives the transmitted signals from each sector 84. The received signals pass through a duplexer or switch 72 to a joint detection device 76. Each sector's downlink data is detected by the joint detector 76 in its respective time slot. The soft symbols of the detected downlink data from each of the N timeslots is stored in a buffer 80. Each version of the dectected soft symbols of the detected data received in the N timeslots are then preferably combined by a combiner 82 to produce the downlink data. Alternately, instead of combining, the sector data having the best received quality is selected. The buffering and combining is controlled by a softer handover controller 78.

A code assignment receiver 74 receives the code assignments sent by the sectors 84. For the uplink, uplink data is processed by a transmitter 68. An amplifier 70 controls the transmission power level in response to a power controller 66. The amplified signal passes through a duplexer or switch 72 and is radiated by the antenna/antenna array 64 through the air interface 38.

Each sector's antenna or antenna array 88 receives the uplink transmissions. These received signals pass through a duplexer or switch 98 to a joint detector 100₁ to 100_{N} (100), which recovers the uplink data. The data produced by each joint detector 100 is stored in a buffer 102. A combiner 104 combiners the recovered uplink data from both sectors at the symbol level. The combiner 104 and buffer 102 are controlled by a softer handover controller 106.

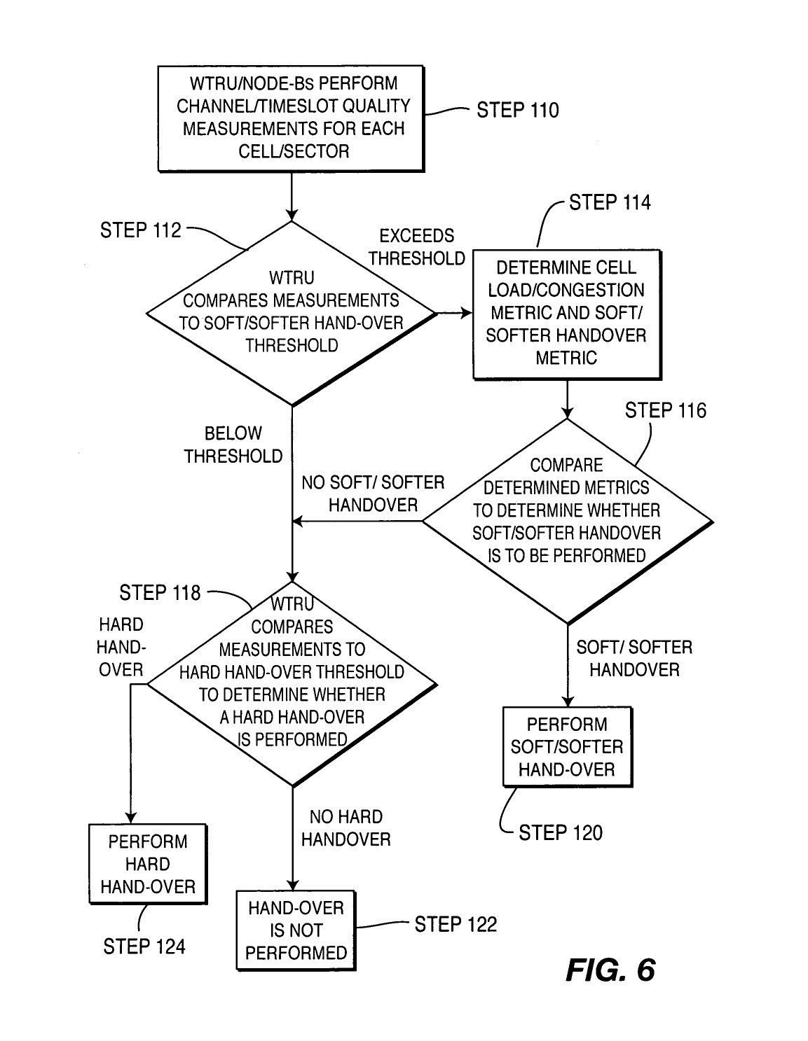

FIG. 6 is a flow chart for an embodiment of using both soft/softer and hard handover. This approach can be applied to any wireless communication system employing handover. A WTRU 34 and base stations/Node-Bs 22 perform channel/time slot quality measurements for each cell/sector (step 110). These measurements include RSCP, interference signal code power (ISCP) and pathloss measurements.

The WTRU 34 compares these measurements to a soft/softer handover threshold (step 112). If the measurements exceed the threshold, a cell load/congestion metric and a soft/softer handover metric are determined (step 114). The cell load/congestion metric is a measure of each cell's loading or congestion. The soft/softer handover metric is a measure of the gain expected from initiating soft/softer handover.

The two metrics are compared to determine whether soft/softer handover should be performed (step 116). To illustrate, if a perspective handover cell has a high congestion and the anticipated soft handover gain is small, soft handover is not initiated. Alternately, if the perspective handover cell is light congested and the soft handover gain is large, soft handover is initiated.

If it is determined that soft/softer handover should be performed, soft/softer handover is initiated (step 120) If soft/softer handover is not to be performed or the measurements did not exceed the soft/softer handover threshold, the measurements are compared to a hard handover threshold (step 118). If the measurements do not exceed the hard handover threshold, neither hard nor soft/softer handover are performed (step 122). If the threshold is exceeded, hard handover is performed (step 124).

1. A method for soft/softer handover in a wireless hybrid time division/code division multiple access communication system, the method comprising for a wireless transmit/receive unit (WTRU):
determining currently used uplink and downlink timeslots of the WTRU in a current cell/sector;
assigning uplink and downlink timeslots to the WTRU for a handover cell/sector, the assigned handover cell/sector uplink and downlink timeslots are different timeslots than the currently used current cell/sector uplink and downlink timeslots; and
after initiating soft handover, communicating same uplink and downlink data with the current cell/sector using the currently used uplink and downlink timeslots and with the handover cell/sector using the assigned handover cell/sector uplink and downlink timeslots.

2. The method of claim 1 for use in a time division duplex system wherein the assigning handover cell/sector uplink and downlink timeslots to the WTRU is only to timeslots having a same direction as timeslots in the current cell/sector.

3. The method of claim 1 wherein the uplink and downlink data is decoded using a joint detector configured to only process signals sent by a same scrambling code.

4. The method of claim 1 further comprising one set of the same uplink data having a highest received signal quality received by each cell/sector being selected as decoded uplink data.

5. The method of claim 1 further comprising combining both sets of the same downlink data as decoded downlink data.

6. A wireless transmit/receive unit (WTRU) capable of performing soft/softer handover in a wireless hybrid time division duplex/code division multiple access communication system, the WTRU comprising:
a transmitter using a current uplink timeslot to transmit uplink data to a first cell/sector;
a receiver using a current downlink timeslot to receive downlink data from the first cell/sector;
a code assignment receiver for receiving a handover uplink and downlink timeslot assignment, the handover uplink and downlink timeslot assignment indicating timeslots other than the current uplink and downlink timeslot; and
the transmitter for transmitting the uplink data to the first cell/sector using the current uplink timeslot and to a handover cell/sector using the assigned handover uplink timeslot; and
the receiver for receiving the downlink data from the first cell/sector using the current downlink timeslot and from the handover cell/sector using the assigned handover downlink timeslot.

7. The WTRU of claim 6 further comprising a joint detector for detecting the received downlink data for the first cell/sector and the handover cell/sector.

8. The WTRU of claim 7 further comprising a buffer for storing the detected received downlink data for the first and handover cell/sector.

9. The WTRU of claim 8 further comprising a combiner for combining the detected received downlink data of the first and handover cell/sector.

10. The WTRU of claim 6 wherein a transmission power level of the first cell/sector transmitted uplink data is based on a received signal power level (RSCP) of a channel transmitted by the first cell/sector and a transmission power level of the handover cell/sector transmitted uplink data is based on a RSCP of a channel transmitted by the second cell/sector.

11. The WTRU of claim 10 wherein the RSCP of the first and handover cell/sector channels are determined in a same radio frame.

12. The WTRU of claim 10 wherein the RSCP of the first and handover cell/sector channels are not determined in a same radio frame.

13. The WTRU of claim 6 wherein a transmission power level of the first cell/sector uplink communication is based on a pathloss of a channel transmitted by the first cell/sector and a transmission power level of the handover cell/sector is based on an offset of the first cell/sector pathloss.

14. The WTRU of claim 13 where the offset is updated periodically.

15. A wireless transmit/receive unit (WTRU) capable of performing soft/softer handover in a wireless hybrid time division duplex/code division multiple access communication system, the WTRU comprising:
means for using a current uplink timeslot to transmit uplink data to a first cell/sector;
means for using a current downlink timeslot to receive downlink data from the first cell/sector;
means for receiving a handover uplink and downlink timeslot assignment, the handover uplink and downlink timeslot assignment indicating timeslots other than the current uplink and downlink timeslot; and
means for transmitting the uplink data to the first cell/sector using the current uplink timeslot and to a handover cell/sector using the assigned handover uplink timeslot; and
means for receiving the downlink data from the first cell/sector using the current downlink timeslot and from the handover cell/sector using the assigned handover downlink timeslot.

16. The WTRU of claim 15 further comprising a joint detector for detecting the received downlink data for the first cell/sector and the handover cell/sector.

17. The WTRU of claim 16 further comprising a buffer for storing the detected received downlink data for the first and handover cell/sector.

18. The WTRU of claim 17 further comprising a combiner for combining the detected received downlink data of the first and handover cell/sector.

19. The WTRU of claim 15 wherein a transmission power level of the first cell/sector transmitted uplink data is based on a received signal power level (RSCP) of a channel transmitted by the first cell/sector and a transmission power level of the handover cell/sector transmitted uplink data is based on a RSCP of a channel transmitted by the second cell/sector.

20. The WTRU of claim 19 wherein the RSCP of the first and handover cell/sector channels are determined in a same radio frame.

21. The WTRU of claim 19 wherein the RSCP of the first and handover cell/sector channels are not determined in a same radio frame.

22. The WTRU of claim 15 wherein a transmission power level of the first cell/sector uplink communication is based on a pathloss of a channel transmitted by the first cell/sector and a transmission power level of the handover cell/sector is based on an offset of the first cell/sector pathloss.

23. The WTRU of claim 22 where the offset is updated periodically.

24. A method for determining a type of handover in a wireless communication system, the method comprising:
performing measurements on a plurality of cells/sectors;
using the measurements, determining whether soft/softer handover should be performed using a threshold test; and
if the determination is not to perform soft/softer handover, using the measurements, determining whether hard handover should be performed using a threshold test.

25. The method of claim 24 wherein the determining whether soft/softer handover should be performed includes if the measurements exceed a threshold, comparing a cell loading/cell congestion metric to a soft/softer handover gain metric to determine whether soft/softer handover should be performed.
